(19) United States
(12) Patent Application Publication
(10) Pub. No.: US 2009/0182609 A1
(43) Pub. Date: Jul. 16, 2009

(54) SYSTEM AND METHOD FOR ASSESSING FIT BETWEEN A BUSINESS ISSUE AND PERCEPTION OF THE ISSUE BY POTENTIAL SOLUTION PROVIDERS

(76) Inventor: Michael Kelleher, Mt. Pelerin (CH)

Correspondence Address: MOETTELI & ASSOCIATES SARL, ST. LEONHARDSTRASSE 4, ST. GALLEN, CH-9000, CH

(21) Appl. No.: 12/233,759

(22) Filed: Sep. 19, 2008

Related U.S. Application Data
(60) Provisional application No. 60/973,610, filed on Sep. 19, 2007.

(51) Int. Cl. G06Q 10/00; G06N 5/02

(52) U.S. Cl. 705/9; 706/54; 705/11

(57) ABSTRACT

A system is provided for screening requests for proposal and matching the requests with high potential solution providers. The system includes a host computer, a screening and matching process, a proposal request key generator, and a response key generator. The host computer is in communications with a computer network. The screening and matching process is resident and executable on the host computer. This process is adapted to accept data input from a proposal requestor and from a proposal responder and to output data to the proposal requestor and to the proposal responder, and to define a requirements data set and to receive a response data set. The response key generator generates a key that represents the proposal responder's reply to the requirements data set. The response key is processed with the request key to provide a proposal key which is output from the host computer via the computer network to the proposal requestor. The requirements data set is operated on by the screening and matching process to provide the proposal request key. The proposal response key enables the requestor to vet through several candidate responses and choose one which has a high potential of offering a suitable solution.

Priority to U.S. provisional application Ser. No. 60/973,610 is claimed.

### BACKGROUND OF THE INVENTION

The present invention is in the field of data processing for business practices and management. Specifically, the present invention relates to computer systems and corresponding methods wherein the method is uniquely designed for or utilized in the practice, administration, or management of an enterprise. More specifically, the present invention relates to arrangements used for identifying and solving problems relating to administration of an organization and/or its transactions, strategies, products and services.

Online advice is provided via websites like www.answers.yahoo.com. This forum provides a means to ask a question and propose an answer. However, other than a ranking that an answer provider earns through the review or comment, or ranking by those who have posed questions, there is no way to ascertain in a quick visual manner, whether an answer provider indeed has a promising answer, or whether he understands in any detail the question in the context of the requestor, or that he has really taken the time to think through the issues, or that he has the requisite technical knowledge or experience to provide a valuable answer.

Current practice in the field it is concerned with systems and methods for Corporate inquirers to find suitable consultants (usually for a low cost or as additional outsourced resources for an often fully conceptualized project that the Corporate is looking to have implemented) based on matching keywords (meta-tags, etc.) and stated areas of expertise and knowledge against what the Corporate is looking for in a consultant. Usually this results in the output of a list of suitable consulting candidates and perhaps a ranking of those candidates. A request for proposal may then be broadcast specifically to those consultants and/or generally into the field.

It would be beneficial in the field for a corporate inquirer to be able to match or find consultants (especially business “thinkers” in the field) and create a general relationship which then result at some point in the process with specific paid tasks being commissioned by the corporate inquirer with a specific business thinker or subset of business thinkers regarding a specific business issue.

It would be further beneficial to be able to generate ideas which are solutions to a corporate's business issue online and pretty much in real-time, as opposed to the current method of generally broadcasting a pre-prepared request for proposal (RFP) to locate a suitable consultant, with a subsequent step being the commissioning of actual projects to solve business issues.

What is needed therefore is a system and method that provides a visual indication of the likely relevance of a particular responder's answer to a specific business issue, without being the actual full written details of that answer.

### SUMMARY OF THE INVENTION

A system is provided for screening requests for proposal and matching the requests with high potential solution providers. The system includes a host computer, a screening and matching process, a proposal request key generator, and a response key generator. The host computer is in communications with a computer network. The screening and matching process is resident and executable on the host computer. This process is adapted to accept data input from a proposal requestor and from a proposal responder and to output data to the proposal requestor and to the proposal responder, and to define a requirements data set and to receive a response data set. The proposal request key generator operates on the host computer via the computer system network generating a key representing the requirements data set and to output a proposal request to a proposal responder. The response key generator generates a key that represents the proposal responder's reply to the requirements data set. The response key is processed with the request key to provide a proposal key which is output from the host computer via the computer network to the proposal requestor. The requirements data set of the proposal request is enterable into the screening and matching process by the proposal requestor. The requirements data set is operated on by the screening and matching process to provide the proposal request key. The response data set is enterable into the screening and matching process by the proposal responder.

An object of the invention is that the response key. generated by operation of the response key generator operating on by the screening and matching process, indicates the likely relevance of the response to the query posed, thereby enabling the requestor to vet through several candidate responses and choose one which has a high potential of offering a suitable solution.

In an advantage, the Key reverses the normal obligation on the requestor, which normally has to expend considerable time reviewing proposals to try and think or perceive whether the responder understands his issue and therefore whether his idea is likely to be relevant. Significantly, once the requestor completes the requirements data set and the key generator generates a proposal request key, the onus is shifted to the responder to prove this via a good key fit, rather than the requestor having to try and guess or perceive it.

### BRIEF DESCRIPTION OF THE DRAWINGS

Referring now to the drawings, the details of preferred embodiments of the present invention are graphically and schematically illustrated. Like elements in the drawings are represented by like numbers, and any similar elements are represented by like numbers with a different lower case letter suffix.

FIG. 1 is a block diagram showing the general structural elements of the present invention.

FIG. 2 is a block flow diagram of the overall assessment method of the present invention.

FIGS. 3A to 3D are a printout of the proposal request function GUI that allows the proposal originator to load its business issue parameters data set into the enabling process of the present system.

FIGS. 4A and 4B respectively are schematic diagrams of the business issues “Key” of the originator/requestor as the Key may be initially generated (A) by the enabling process, and as it may be scrambled (B) by the process for preparation of a “blank Key.”

FIG. 5A is a schematic diagram of a “blank Key” as received by a prospective responder.

FIG. 5B is a schematic diagram of a “proposed business issues Key” as prepared by a responder to the RFP of the originator.

FIGS. 6 and 6A are schematic diagrams in of graphic assessment of the fit between the originator's business issue Key and the responder's proposed Key.

FIGS. 7A to 7C are a printout of the details of an Assessment or comparison assessment of fit between an originators perception of a business issue and the perception of the issue by the understanding or perception that the originator relative to a solution as perceived by a provider/responder has of the originator's perception of the business issue, on the other.

### DETAILED DESCRIPTION OF THE PREFERRED EMBODIMENT(S)

In a current idea marketplace/forum, the BT would prepare in full detail a response to on or more RFPs and send it to the corporate inquirer for review. A risk for the BT is that an inquirer may not actually go ahead then and commission the proposal, especially if it is a concept proposal, and just say that they already knew of that idea. It would be beneficial to the field if the BT could submit its proposal to a third party for verification, which third party would confirm for the inquirer that the proposal concept/idea exists in written form, appeared complete, looks professional and relevant, etc., so that the inquirer then has the confidence to commission the full-blown proposal from the BT. It would be beneficial if the BT did not have to initially prepare and submit a full-blown proposal, but could instead prepare and submit a substantially less detailed but conceptually sufficient initial proposal, because if the BT has to fully write up each idea and he/she has no commitment from a requestor that it will pay for any write-up and he/she only ends up being commissioned on a couple of them—this becomes a very inefficient and unworkable process for him/her.

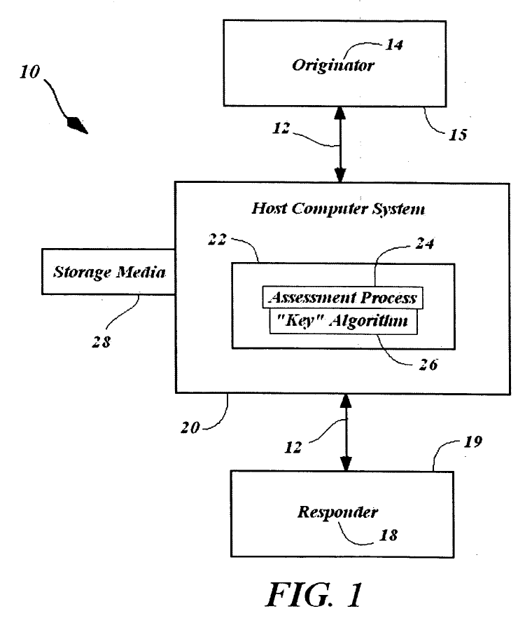

As illustrated in FIG. 1, the present invention is system 10 for screening requests for proposal and matching said requests with high potential solution providers (BTs). The present system 10 assesses the extent to which a BT responder 18 to an RFP similarly perceives and understands the originator/requestor's 14 perception of a specific business issue in a relative the business issue as perceived by originator/requestor 14 of the RFP, across all of its aspects—for example, technical aspects, commercial aspects, regulatory aspects, marketing aspects, distribution aspects, the profile of the originator/requestor 14 etc as relevant to that specific issue.

The present invention 10 is a system and method for assessing fit between a business issue and perception of the issue by potential solution providers. The system 10 comprises a host computer system 20 in communications with a computer system network link 12, an enabling process 22 resident on the host computer 20, an originator/requestor node 15 and a responder/BT node 19. In the example illustrated the enabling process 22 included a website and assessment process 24 resident on a computer server system 20 and the computer system network link 12 was connectivity with a global computer system network (the Internet). The requestor and BT nodes 15 & 19 in the present example each is a personal-type computer system having connectivity to the host computer system 20 via the network link 12, however, any type of digital communications mechanism which can communicate with the host computer system 20 may serve as a node.

The enabling process 22 comprises instructions stored on a data storage media 28 in communications with the host computer system 20. Included in the instructions of the enabling process 22 is an assessment process 24. The assessment process 24 accepts data input from a proposal requestor 14 and from a proposal responder 18 and provides output data to the proposal requestor 14 and to the proposal responder 18. The assessment process 24 includes a “Key” generation and comparison algorithm 26.

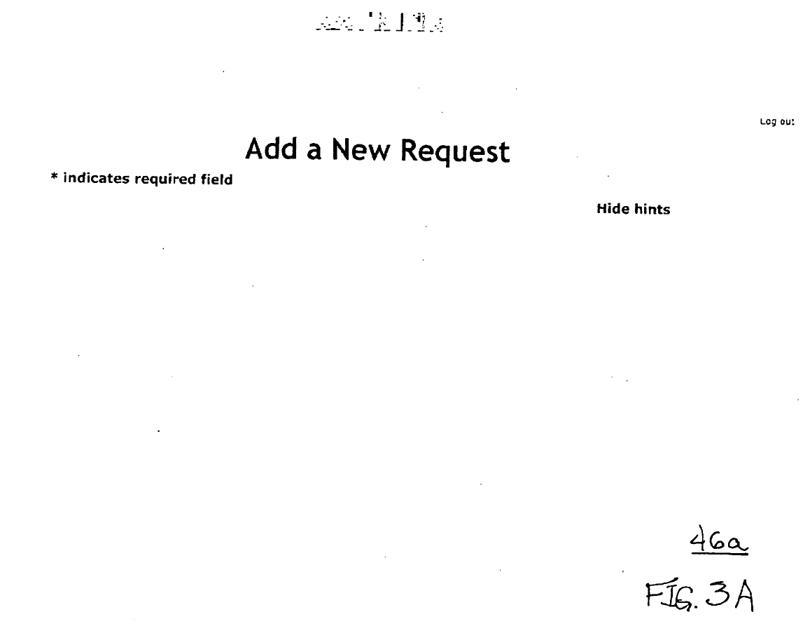

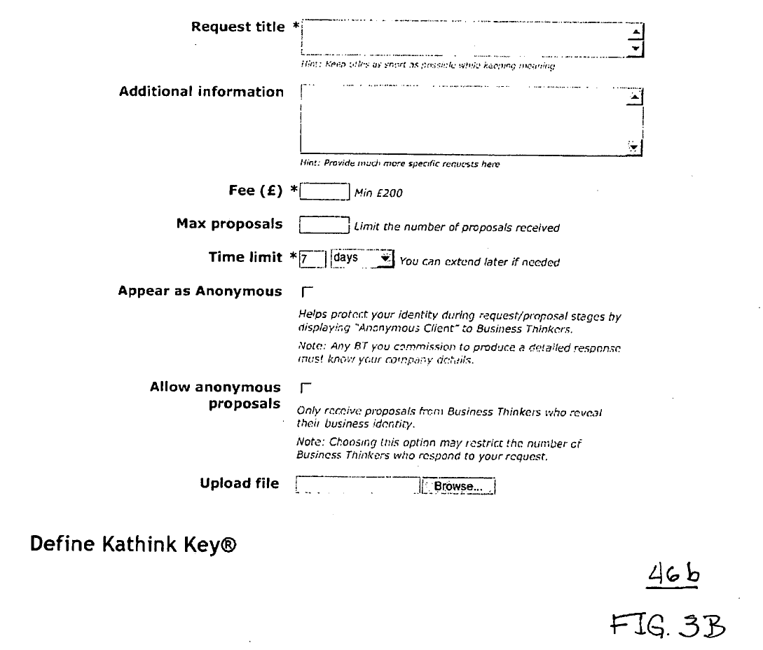

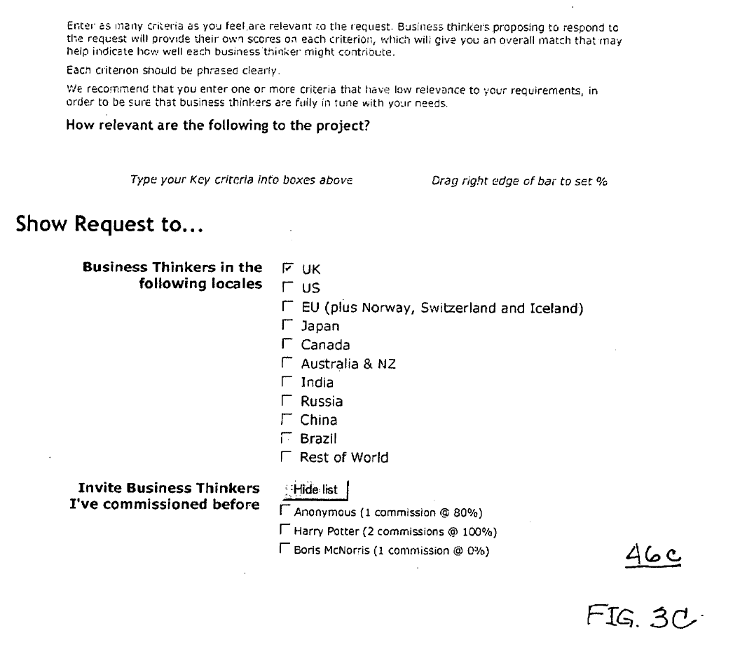

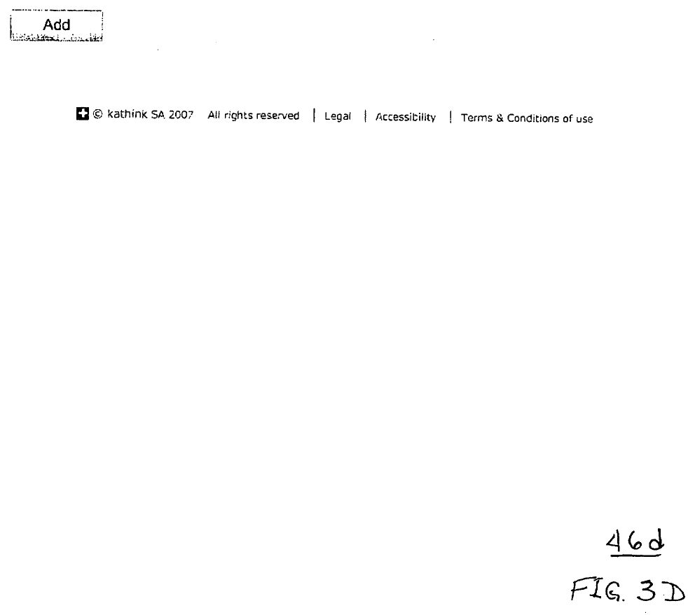

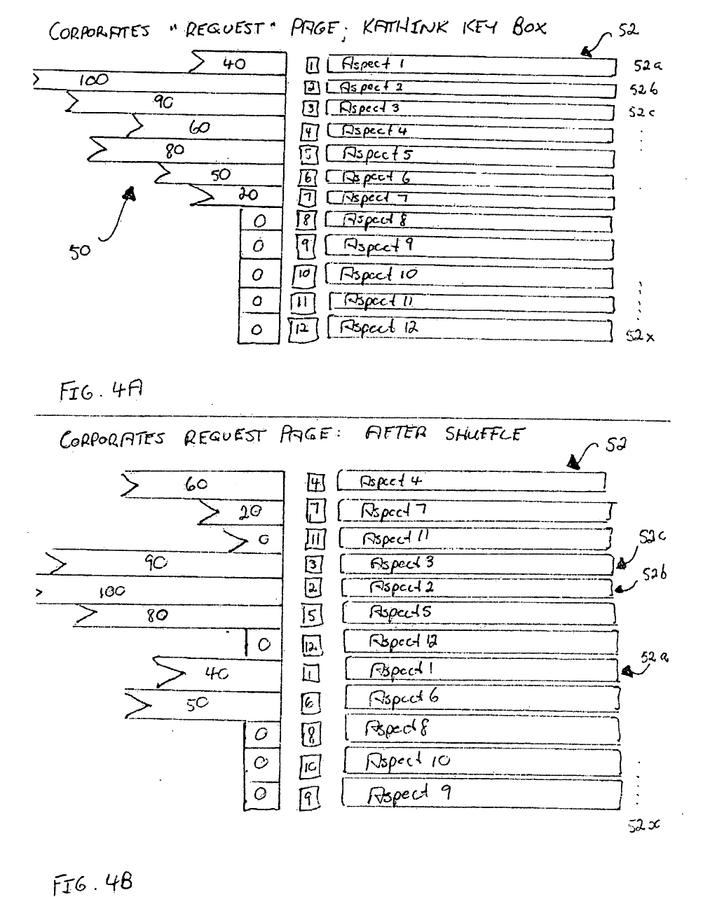

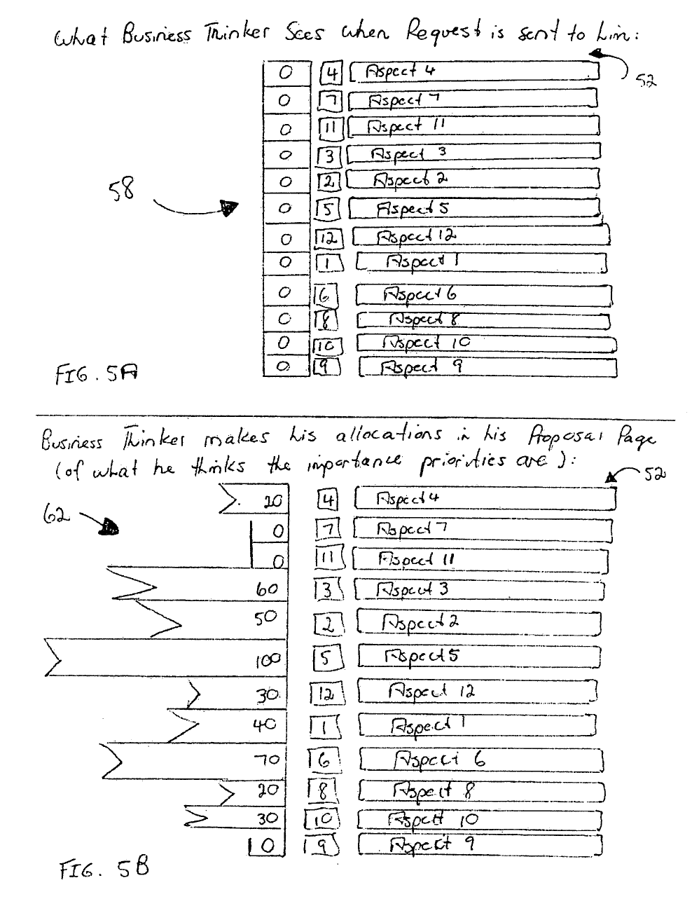

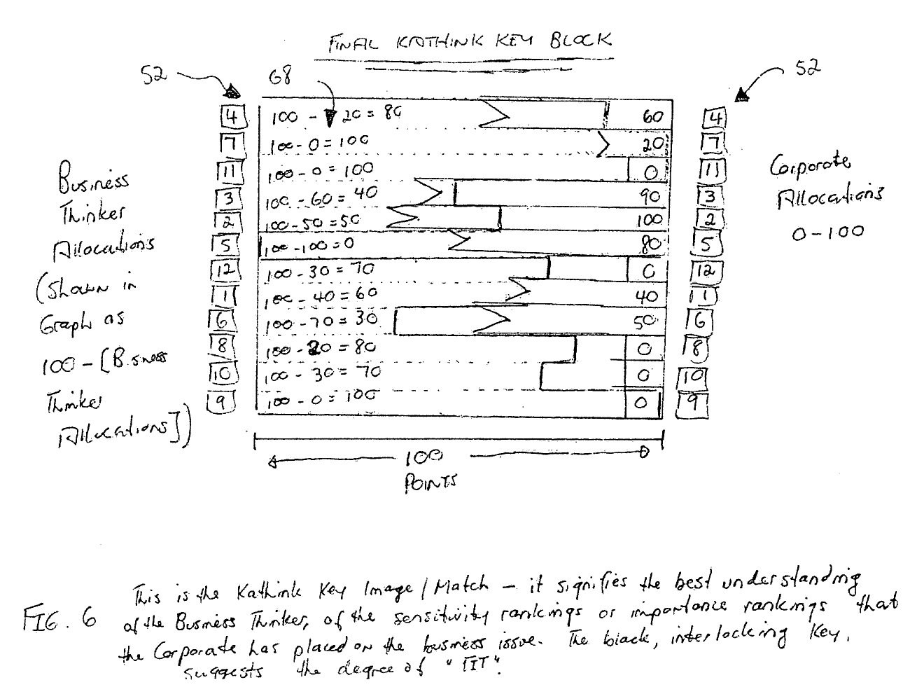

The requestor 14 accesses 44 the host computer system 20 and runs a proposal request function 44 of the enabling process 22. The proposal request function 44 provides a GUI 46a-d (see FIGS. 3A-3D) to the originator node 15 that allows the originator 14 to load its business issue parameters data set 48 into the enabling process 22. The issue requirements data set 48 is then operated on by the screening and matching (assessment) process 24 to provide a proposal request key 50 representing the business issue requirements data set 48. See FIG. 4A. The assessment process 24 of the system 10 scrambles the order of the items of business issue parameters data set 48 from that as input by the originator 14, to prevent a responder 18 from knowing the prospective ranking and hence weighting of the items by the originator 14, on the precept that most originators 14 when completing a request key will start with the most important aspects at the top of the key and work downwards. The act of scrambling prevents a responder 18 from simply assigning weightings on this basis with no further thought. This scrambling results in the “scrambled Key” 54 that is basis for the “blank Key” 58 presented to the responder/BT 18 by the assessment process 24. The blank Key 58 (the proposal request key) is output from the host computer system 10 via the computer system network to (selected) proposal responders 18.

It is the blank Key 58 (sec FIG. 5A) that the BT 18 receives from the requestor 14 via the system 10. It is the blank Key 58 that the BT 18 is required to complete by allocating a weight (e.g., a percentage, a numerical value, etc.) to each of the parameter items of the data set 48 that the requestor 14 in it perception has established for the business issue. The BT 18 allocates this weight to each business issue item parameter in accordance with what the BT 18 perceives to be the relative importance that the requestor 14 had attached to each of the defined parameter items 52.

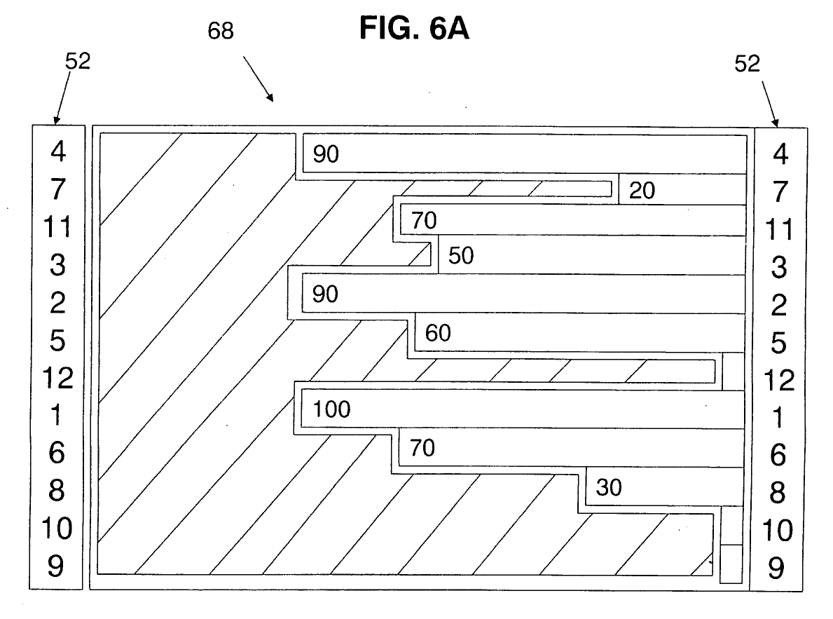

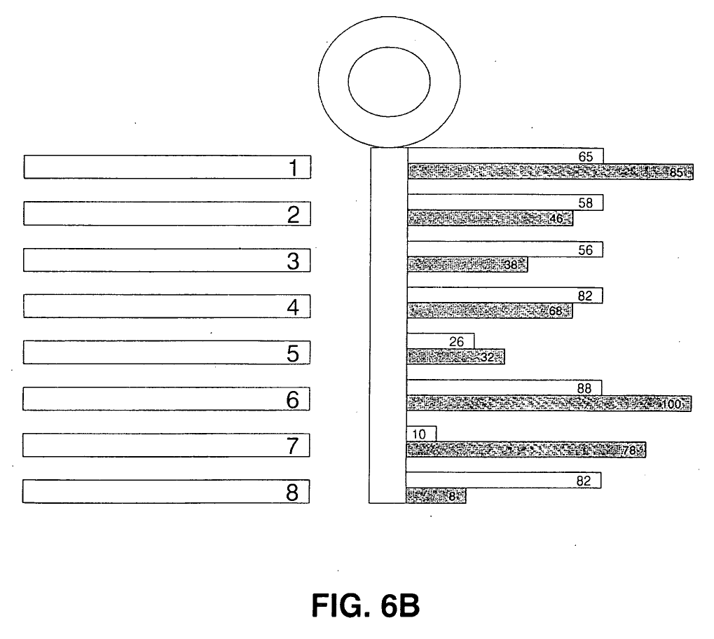

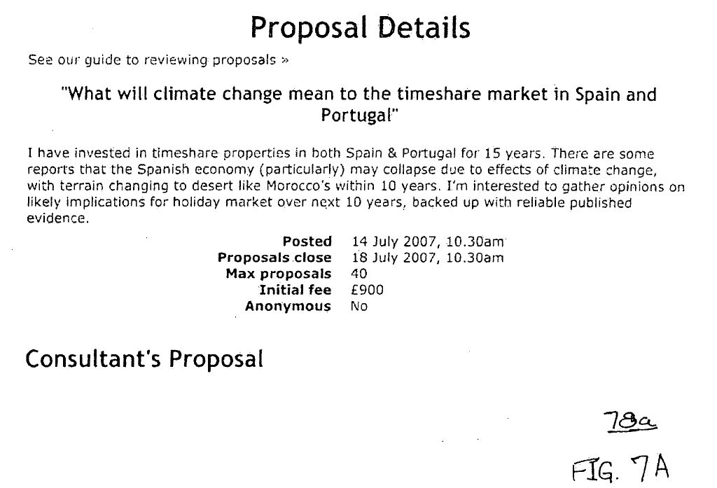

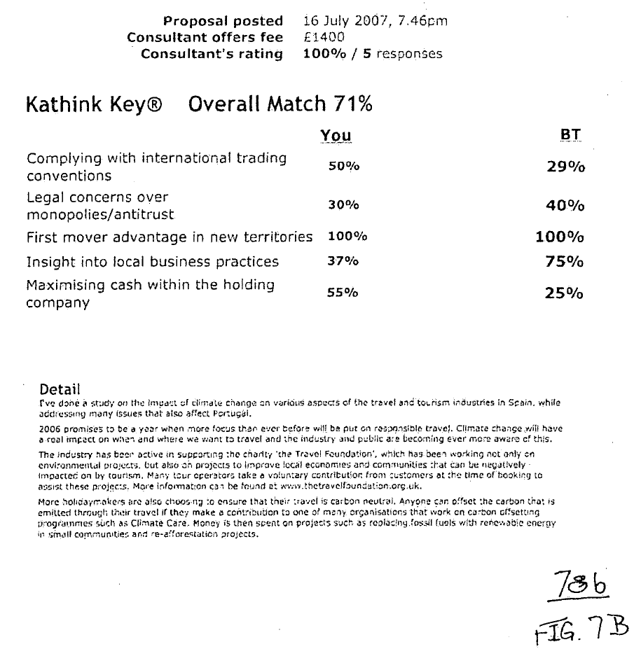

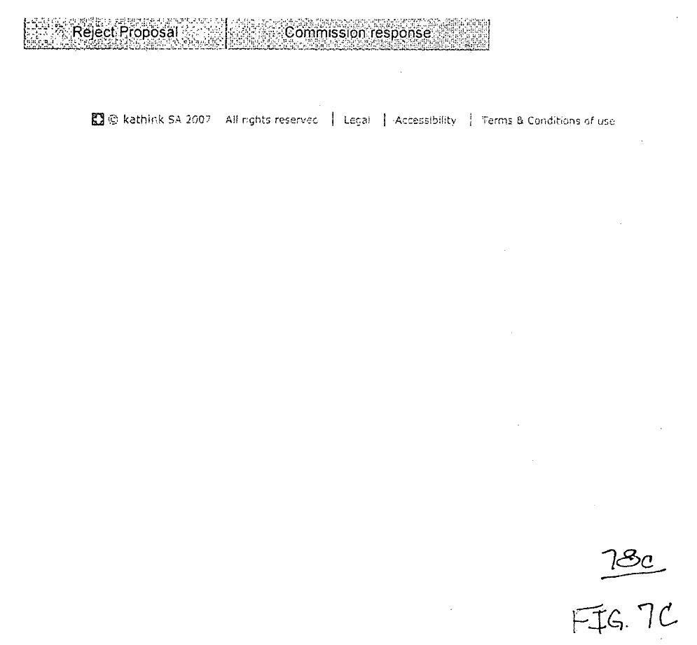

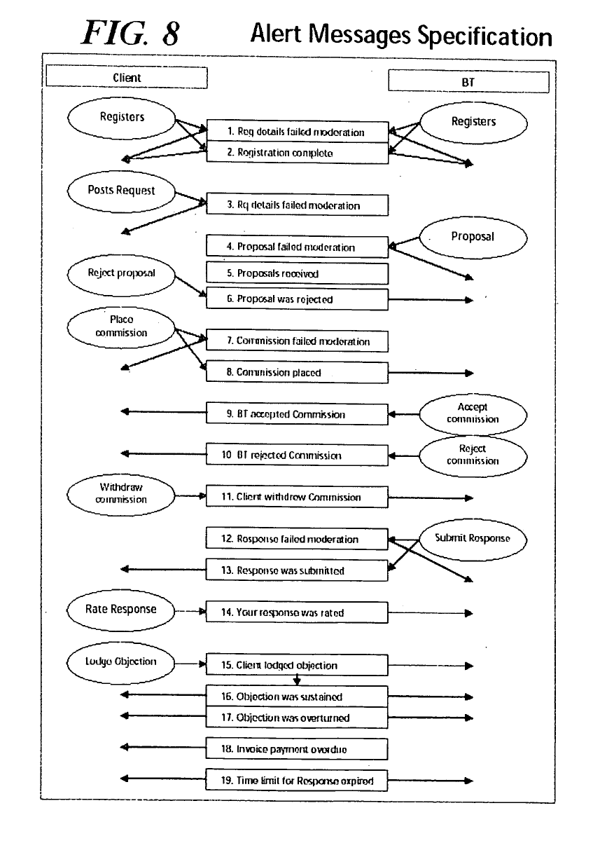

The BT 18 ascribes a weight allocation to each of the defined business issue parameter items 52 of the blank Key via GUI input screen presented on the responder node 19 by the enabling process 22. This input comprises a response data set entered into the screening and matching assessment process 24 by the proposal responder/BT 18. The response data set is operated on by the assessment process 24 to provide a “response Key”62 representing the proposal responder's reply to the blank Key 58. The response Key 62 is processed with the request Key 50 to provide a proposal Key 68 (see FIGS. 6 and 6A) which is output from the host computer system 10 via the computer system network link 12 to the proposal requestor 14. In addition to the “Key” graphics used in the present assessment system 10, textual or narrative details arc generated by the system as well. For example, FIGS. 7A-7C are a printout of a web page report of a hypothetical result of a responders submission of a response Key into the system 10 and transmitted to the originator 14.

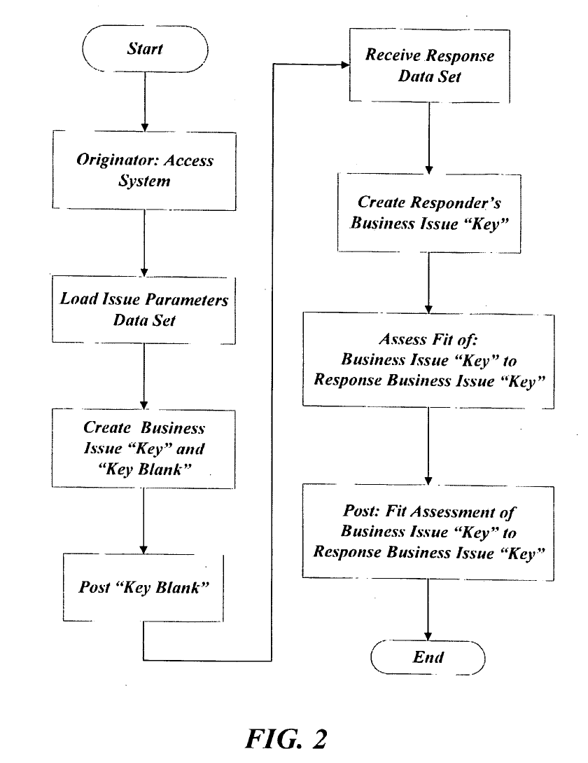

FIG. 2 is a block flow diagram of the overall assessment method of the present invention. Additionally, the enabling process 22 can be adapted to present a variety of feedback responses to originators 14 and responders/BTs 18, as illustrated in FIG. 8 and explained in Tables 1A and 1B. One of ordinary skill in the art would know how to select and implement such support features and feedback mechanism in a process running on a computer system 20 of the present invention.

The key generation and comparison algorithm 26 creates the business issue Key 50, scrambled Key 54 and blank Key 58 from the issue parameter data set 48 input into the system 10 by the issue originator person 14. As noted above, the business issue Key 50 represent a set of issue parameters and originator's set of associated issue weighting factors, and the business issue blank Key 58 being without the associated issue weighting factors. The algorithm presents the business issue blank Key 58 to the responder person 18 and accepts data input of a responder's set of associated issue weighting factors to enable creation of a responder's Key 62. The algorithm also compares the originator's and the responder's set of issue weighting factors to assess the fit of the originator's business issue Key 50 with the responder's Key 58, and outputs the result of the comparison.

In another embodiment, the system and method of the invention allows the requestor to re-fit the response key with his request key by recalculating relevance after throwing out one or two weighing factors. The factors which will not be considered in revaluating key fits are selected by the requestor, or may be randomly selected automatically. Of course, the same factors should be removed from the request key as well as the response key, and therefore two new keys will be compared. In this ease, the fit is recalculated without one or two factors, and the resulting correspondence with the requestor Key revaluated. Under certain circumstances, the requestor will find better matches to his key and then be able to select responses that do not necessarily agree with the requestor's evaluation of the relevance or importance of the issues. In this manner, the requestor will likely consider responses that appear to understand the issues but that disagree with the requestor's assessment, thereby allowing those responders who are competent but think outside the box to have their views considered.

An object of the invention is that response key, generated by operation of the response key generator is operated on by the screening and matching process, indicates the likely relevance of the response to the query posed, thereby enabling the requestor to vet through several candidate responses and choose one which has a high potential of offering a relevant and suitable solution.

In an advantage, the Key reverses the normal obligation on the requestor, which normally has to expend considerable time reviewing proposals to try and think or perceive whether the responder understands his issue and therefore whether his idea is likely be relevant. Significantly, once the requestor completes the requirements data set and the key generator generates a proposal request key, the onus is shifted to the responder to prove this via a good key fit, rather than the requestor having to try and guess or perceive it.

TABLE 1
FIG. 8 Legend

| | |
|---|---|
| 1. | Reg details failed moderation |
| | The registration details you provided failed our moderation checks. |
| | You will not be able to post Requests on Kathink until your registration data are |
| | successfully validated. Please review and resubmit your details |
| 2. | Registration complete |
| | Your registration is now complete and fully activated. You are now able to commission |
| | detailed responses from Business Thinkers. |
| 3. | Request details failed moderation |
| | The request you posted <<ITEM>> (<<DATE>>) failed our moderation checks. Please |
| | review the terms & conditions and resubmit the request. |
| 4. | Proposal failed moderation |
| | The proposal you submitted for <<ITEM>> (<<DATE>>) failed our moderation checks. |
| | Please review the terms & conditions and resubmit the proposal. |
| 5. | Proposals received |
| | You have 8 new Proposals for <<ITEM>> (<<DATE>>). |
| 6. | Proposal was rejected |
| | The client rejected your proposal for <<ITEM>> (<<DATE>>). |
| 7. | Commission failed moderation |
| | The commission you submitted to <<BT>> for <<ITEM>> (<<DATE>>) failed our moderation |
| | checks. Please review the terms & conditions and resubmit the commission. |
| 8. | Commission placed |
| | The client <<CLIENT>> accepted your proposal tor <<ITEM>> (<<DATE>>) and has |
| | commissioned a full response. |
| 9. | BT accepted commission |
| | The Business Thinker <<BT>> accepted your commission for <<ITEM>> (<<DATE>>). |
| 10. | BT rejected commission |
| | The Business Thinker <<BT>> rejected your commission for <<ITEM>> (<<DATE>>). |
| 11. | Client withdrew commission |
| | The client withdrew their previous commission for <<ITEM>> (<<DATE>>). The commission |
| | is no longer valid. Do not proceed with any work, as the client is not liable to pay you. |
| 12. | Response failed moderation |
| | The detailed response you submitted for <<ITEM>> (<<DATE>>) failed our moderation |
| | checks. Please review the terms & conditions and resubmit the response. |
| 13. | Response was submitted |
| | Business Thinker <<BT>> has submitted a response for <<ITEM>> (<<DATE>>). |
| 14. | Your response was rated |
| | Your submission for <<ITEM>> (<<DATE>>) was accepted by the client (rated <<N%>>) |
| 15. | Client lodged objection |
| | The client <<CLIENT>> lodged an OBJECTION against your response for <<ITEM>> |
| | (<<DATE>>). The objection will be reviewed by Kathink Customer Services, and you will be |
| | notified whether it will be upheld or overturned within 7 days. |
| 16. | Objection was sustained |
| | (To client): Your OBJECTION against the response by Business Thinker <<BT>> |
| | for <<ITEM>> was SUSTAINED. You will not be held liable to pay any fees for this response. |
| | (To 8T): Sorry, but the client's OBJECTION against your response for <<ITEM>> was |
| | SUSTAINED. You will not be able to claim fees from the client for this response. |
| 17. | Objection was rejected |
| | (To client): Sorry, but your OBJECTION against the response by Business Thinker <<BT>> |
| | for <<ITEM>> was REJECTED. You are still liable to pay the fees agreed for the service |
| | provided. |
| | (To BT): The client's OBJECTION against your response for <<ITEM>> was REJECTED. You |
| | are still entitled to receive the fees agreed for the service provided. |
| 18. | Invoice payment overdue |
| | Fee payment for response by <<BT>> for <<ITEM>> (<<DATE>>) is overdue. Please note, |
| | fees to Kathink are payable within 21 days of submission of the response. Read notes on |
| | paying fees. |
| 19. | Time limit for response expired |
| | (To client): The TIME LIMIT you set for business thinker <<BT>> for <<ITEM>> (<<DATE>>) |
| | has EXPIRED. You may extend the time limit if you wish. Otherwise, you will not be liable |
| | to pay any fees. |
| | (To BT): The time limit for <<ITEM>> from client <<CLIENT>> has EXPIRED. You can no |
| | longer submit a detailed response, unless the client extends the time limit for submission. |

The patents and articles mentioned above are hereby incorporated by reference herein, unless otherwise noted, to the extent that the same are not inconsistent with this disclosure.

Other characteristics and modes of execution of the invention are described in the appended claims.

Further, the invention should be considered as comprising all possible combinations of every feature described in the instant specification, appended claims, and/or drawing figures which may be considered new, inventive and industrially applicable.

Multiple variations and modifications are possible in the embodiments of the invention described here. Although certain illustrative embodiments of the invention have been shown and described here, a wide range of modifications, changes, and substitutions is contemplated in the foregoing disclosure. While the above description contains many specifics, these should not be construed as limitations on the scope of the invention, but rather as exemplifications of one or another preferred embodiment thereof. In some instances, some features of the present invention may be employed without a corresponding use of the other features. Accordingly, it is appropriate that the foregoing description be construed broadly and understood as being given by way of illustration and example only, the spirit and scope of the invention being limited only by the claims which ultimately issue in this application.

### DISCLOSURE APPENDIX

If a Corporate receives back many keys which consistently show a strong allocation on a particular aspect where the Corporate employee has shown a low or very low allocation, then the Corporate employee is prompted to examine his own understanding of that aspect of the issue—has he misunderstood that aspect or its importance. This of itself could be a valuable piece of information for the Corporate, and he gets this without having to commission anything.

An advanced version of the Key should provide that the BT is able to add aspects to the key set by the Corporate, and to suggest percentage allocations to these, especially where the BT thinks that a key aspect has not be listed by the Corporate and therefore the Corporate is missing this aspect of the issue. In a later version of the BT Proposal form, the BT will be able to specifically comment on the key set by the Corporate and raise there any aspects which he thinks that the Corporate has missed or does not understand.

Another function of the Key is to set out a series of aspects of a particular Request, which acts as a trigger for the BT to start thinking creatively as to what a winning solution to the problem could be. That is, by being forced to complete allocations on the Corporate's key for that issue, the BT has to first consider all the aspects of the Issue, which is a running start for the BT to conceive the solution.

The Corporate actually saves money using kathink plus then a lower involvement of its traditional external advisers, resulting in a lower overall cost to the Corporate for strategy conception plus implementation, then the current method where the external consultants are also engaged in the concept advice, resulting in high external consulting fees for the Corporate.

Another core purpose for kathink, is to come between all Corporates and their current, existing external advisers. Kathink becomes a first port of all for all Corporate thought generation. So rather than employees of Corporates just throwing issues like usual out to their specialist external advisers, kathink permits the leveraging of the brainwpower and capabilities of Corporate employees such that they can use kathink's BTs to develop ideas and concepts on structures, strategies to a much greater extent internally, before they then take the chosen strategy or 2 out to their external advisers for detailed review and implementation.

I believe there would be a real interest in all Corporates going forward hiring internally personnel who can pretty much handle full circle concept and strategy creation for the Corporate's business issues, supported and leveraged by a global business concept tool such as kathink. From there, the Corporate throws the pretty much completed concept out to its trusted offline advisers for vetting and final comments.

Kathink however via the key permits the Corporate to receive back the BT's Proposal which contains his Pitch (just a brief outline of the core idea, so the Corporate has to commission the full details if he likes the idea) plus the key fit. if the Pitch is interesting, and the key fit is good, then the Corporate knows that (i) the BT has fully thought though the issue, as he could not have allocated a good key fit without doing so, and that a full idea is very likely to exist and that that idea is very likely to be contextually sensitive and relevant to the Corporates business, and probably able to be implemented. So the Corporate then has real confidence to go ahead and commission the full details of the idea, sight unseen. Which is the very essence of the business model of kathink, and the core invention and functionality that we need to patent to prevent competitors trying to rollout copy cat businesses.

Re the last paragraph below, instead of “captures” we could alternatively say that the Kathink Key “guages” the extent to which the completor of the defined Key has PERCEIVED the relative importance of the defined aspects of the Issue to the Setter of the Key. Again, the completor of the Key can only complete a Key which is a close or accurate match to the master key set by the Settor, if he takes the time to completely think through the whole Issue, in the context of what he knows about the Settor of the Key and the business environment in which that Settor is operating. So a good key fit gives the Settor some real confidence that the BT has fully thought through the Issue presented to him before he prepared his Proposal. I think given the Prior Art that you have identified, the closest we seem to come to an already existing patent is systems for “matching” clients with consultants based on data that they register about themselves and their fields and years of experience etc. So I think that on kathink we should never use the word or concept of a BT (Business Thinker) completing and submitting a completed key which is a good “match” to the Settor's Key. We need to move away completely from any “matching” concept or words. Instead we could use the term “Fit”-“a good Kathink Key Fit”, “a close Fit on the Key” etc. After we launch I am going to trademark “The Kathink Key” and also the way Kathink is shown on block gold letters, plus the look of the Key—we will develop a standard look for a defined Key which will be the symbol of the site.

A good key fit back from a completor of a key is also a good indication that the Proposal is likely to be RELEVANT to the Settor's Issue. As you know, RELEVANCE is the holy grail of where ecommerce is heading—how to direct ads to online consumers which are relevant to them (better for the user and the ad service is able to charge the advertiser more money for the ad delivery if it can DEMONSTRATE greater relevancy on the ads delivered (to the right potential consumers, at the right potential time). So we need to patent the Kathink Key also as a new, innovative method and system for certifying, verifying relevance to online (any transaction where the parties do not know each other) transactions, with all the broad and extended potential applications of this.

Note, that at the centre of kathink is an algorithm for the workings of the key, which we have to patent. It works as follows. 1. The Corporate employee sets the key for his Business Issue by defining the aspects of the issue and allocating percentages against them as to which are the most important aspects and which are the least. 2. The system scrambles the vertical order of the aspects in the text boxes and hides the Settor's key from the BT. 3. The BT is required to complete the key by allocating percentages against each of the aspects that the settor has set for that issue, in accordance with what the BT PERCEIVES to be the relative importances that the Settor attaches to each of the defined aspects. 4, The Settor receives back via the system the key completed by the BT, and can easily see the degree that the BT has perceived the aspects of his Issue, and generally his overall Issue.

The Kathink Key could be described as “A Real-time (or close to real time) Issue PERCEPTION method and system which captures how completely and how accurately an online completor of a defined key for an Issue, where the completor has never met the Settor of the key, can PERCEIVE the relative importances to the settor of the defined aspects in the key.”

“Also, there is one additional feature of the Kathink Key that I did not emphasise in the Note. That is, once the BT submits his Proposal with his Kathink Key filled out, his key is in fact a key shape, which the Kathink system can automatically map against the secret Corporate key for that Request, and automatically assemble and send to the Corporate an online Report which analyses the BT's key. Eg, any red flag issues hit, and which ones, any red herring issues hit. and which ones, and the points allocated to that erroneous hit, mappings of the BT key against the Corporate key so the Corporate can quickly and easily get a diamatical and also analytical overview and feel for how close the BT's understanding of the business issue and all its sensitivites is to the Corporate's own understanding, and accordingly how relevant the Proposal is likely to be.”

In many cases, the real power of Kathink is that it helps one garner opinions, ideas, creative energy from people who aren't the normal folks a company would typically hire. They may not even be in the same industry, or understand the business jargon, but they may be brilliant enough to come up with an incisive and perfect solution.

Another is an enterprise version of Kathink which would be available for download by the Corporate for a fee. The Corporate would then use the enterprise version (which could be co-branded Kathink and the Corporate's name) for internal brainstorming or knowledge sharing, best practice implementation etc to internally develop ideas for projects etc across all their business issues. Then from there, once they have developed their Base Case on a business issue, they would then be much more willing to post the issue on the external Kathink site, to see if the Base Case they have developed can be beaten by a better idea or solution. This would be fantastic for Corporate branding, and would a huge help in building trust in the website.

Here are some other applications of the Kathink key:

The Kathink key is basically a “fit and understanding” read on an individual, in the context of a specific scenario that the Corporate has. The scenario could be a Request submitted on Kathink, but it could also be:

(i) a job description on a corporate organisation chart. The Corporate has its own list of criteria that the person in that job is expected to be good at, to have an advanced awareness of etc. So HR could use the key to test an existing employee's suitability for a certain role (as part of an annual review or career realignment or warning or exit process), or maybe for a promotion role etc;

(ii) HR could give the key for a role it is recruiting for to external HR consultants, who would then have candidates complete the key for that role just like a BT, and the resulant fit analysis is sent back to the Corporate as part of the recommendation to hire etc;

(iii) we could publish a set of Kathink Key templates for a whole range of careers, taken in some way from experienced industry professionals. So as part of a career guidance process, candidates could look at the keys for different positions in the corporate world, and get a much more detailed understanding of what that career path would really take to work in—they then can decide whether to pursue that path.

Also, the key should be 1000 points, 500 points, percentage points, etc. as the user desires to allow “Corporates” to really get into a lot of detail with the aspects of a task, and the number of red flags and red herrings.

If a BT seriously expected that a Corporate that it has never met was going to pay real money for an idea that send through to the Corporate via the internet, wouldn't the Corporate at least think that the BT's idea would have to be particularly relevant to the Corporate? That is, that you have to put yourself in the shoes of the Corporate and try to understand what its issue is, so that you can then use your creativity and experience to design a solution for it? Or, if you could expect that with little or no thought on your part, you could expect to be paid say 100 dollars for your idea from the Corporate, in order to get paid 1000, you would need to put some serious thought into the problem the Corporate has and how it could best be solved? The Kathink Key analysis is ALSO a tool for the BT to use to help him really focus in on the Corporate, the issue presented, and what a solution could be that could work or beat his base case, and for which the BT gets paid handsomely (and the revenues he gets from the site are also almost his net income from the site—there is almost no cost to the BT running a successful business on kathink.)

Do we really think that Corporates are going to pay for full details on a briefly presented idea? The problem will be that the Corporate will need to have a fairly large amount of detail before it will be confident that this idea is something which is of value for it and for which it should Commission the Detail. But the risk will be that by the time that the Corporate is given so much detail to be comfortable to proceed, it may not need the further detail of the Full Idea, and so there will be no Commission and no monetization of the BTs via the site. On the other hand, if just the core novel idea is presented, with no detail, but a good kathink key fit, at least the Corporate knows (i) the idea is interesting; (ii) it is very likely to have been fully thought through by the BT as he has made a good fit on the key, which can only be done by the BT sitting down and spending time thinking through all the information he has on the Request, and (iii) that the idea in the proposal is very likely to be comprehensive and applicable to the Corporate in the context of its business. One potential problem with kathink will be that BTs just submit ideas, but have not bothered to think through the full solution, so when the Corporate commissions it, there are major deficiencies in the Response, which makes the whole process a bit worthless for the Corporate. BTs could just sit there and punch off a ton of Proposals without thinking through any of them, and try to just con money out of the Corporates. Of course the FeedBack records should capture this behaviour over time, but there will still have been a number of experiences on kathink that were not quality experiences for the Corporate.

### The Kathink Key—What Aspects to Patent?

The Kathink Business Ideas Marketplace

For an online ideas marketplace to work, where Corporates do not know or have any relationship with the Business Thinkers, the Corporates must:
(i) Be tempted to list their business issues, in sufficient detail for a BT to be able to conceive (based on original thought or experience) a solution which is better than the Base Case solution that the Corporate currently has for the issue (whether that solution was developed internally or with established, offline external advisers). The best case here is for the Corporate to be able to list Requests, and get some sort of Key Pitch answer back, for free:
(ii) The Corporate must then be prepared to “commission” full details of ideas that it likes, based only on brief details of the idea. If the BT explains the whole idea to the Corporate in the initial Proposal, then the Corporate will never commission the full details.
(iii) How does the Corporate get sufficient comfort that the Proposal is likely to be a valuable solution for it? By 1. The Pitch in the Proposal; 2. a brief CV and feedback data on the BT from the site; and 3. The match on the Kathink Key which if accurate shows that the BT has at least thought through the issue, can perceive pretty accurately the sensitivities, and is then creating a better solution from that position.
(iv) Thus the KK is the fundamental tool which enables this online business model to work, that is, to monetize. A—WE NEED TO PATENT THIS.
(v) Without the key, the Corporate has only the CVs or the feedback, all of which are not specific to the issue, to gain sufficient confidence to commission. The other alternative is some form of third party verificiation, which involves the verification costs and also that the BT has to actually write out the full solution, ahead of being commissioned to do so—very inefficient for the BT.
(vi) I would also like to Patent the whole Request-Proposal-Commission-Work transfer-Monetisation/Payment Process as novel.

The Kathink Enterprise Application.

A business tool which (i) allows for real-time, entity wide concept and strategy creation by permitting employees remotely to “perceive” the issue the Corporate is planning, (ii) Issues which cannot be resolved internally can then be posted on the external Kathink platform for a better solution, or the current base Case solution can be “stress tested” externally by the Kathink membership. Each Request on the entity variant can be defined specifically to include, exclude certain employees, including code names for actors, security keys on prior Requests etc. (iii) The settor of the key for the internal Request can have his key settings refined by the employee membership base, which in itself may help resolve the issue, (iv) Each Recipient is asked to a. step into the future and look back at the final solution and ask what was the ONE critical change in process or the ONE critical invention which solved the problem, and to identify this and to send it to the Settor. Or to just perceive an answer from the key data and other data that the Settor sent out in the Request, (v) The Settor places the issue in the Issue Solar System and uses visual representations to get to the final solution. The Key permits the employees to PERCEIVE the problem and what the solution could be.

1. Further Applications of the Key
(i) As a HR tool
(ii) As a Project funding approval tool
(iii) As an online survey tool
(iv) To select service providers or fund managers etc—how accurately do they “perceive” what the settors problem is
(v) As a employee bonus entitlement tool
(vi) As part of HR processes eg suitability for a particular promotion etc.

One box in the Corporate's Request page could be a Box that would just set out 20 or so “tag-words” similar in concept to the megatags that you set out in a website page for the search engines to find and catalogue the page, for later reference when a matching search request comes in. In our case each BT would submit as part of his registration process, a list of “tag-words” which he or she wants the opportunity to submit Proposals back to, when a Corporate submits a Request whose tag-words contain any of the tag-words that the BT has listed.

This is how the system's site will make sure that the site directs the Requests through to suitable BTs on the site. All Proposals, Commision rates etc will form part of the BTs feedback records, so they will be encouraged by the site to only list tagwords which they feel they have a lot of relevant knowledge or quality ideas in relation to (otherwise they will always have poor feedback data).

“The Kathink key is basically a “fit and understanding” read on an individual, in the context of a specific scenario that the Corporate has. The scenario could be a Request submitted on Kathink, but it could also be:

(i) a job description on a corporate organisation chart. The Corporate has its own list of criteria that the person in that job is expected to be good at, to have an advanced awareness of etc. So HR could use the key to test an existing employee's suitability for a certain role (as part of an annual review or career realignment or warning or exit process), or maybe for a promotion role etc;

(ii) HR could give the key for a role it is recruiting for to external HR consultants, who would then have candidates complete the key for that role just like a BT, and the resulant fit analysis is sent back to the Corporate as part of the recommendation to hire etc;

(iii) we could publish a set of Kathink Key templates for a whole range of careers, taken in some way from experienced industry professionals. So as part of a career guidance process, candidates could look at the keys for different positions in the corporate world, and get a much more detailed understanding of what that career path would really take to work in—they then can decide whether to pursue that path. Perhaps Kathink provides this for free on the site.”

Another great application of the key could be online surveys. We say to a Corporate—send your product survey to all our BT membership who have a certain level feedback score. The survey aspects arc stored in the text boxes of the kathink key, which the BTs are asked to fill out a key for, assigning relative importances, and submit the completed key via the site back to the Corporate. The Corporate can then review 1000 or so allocations against its understanding of what people want. There could even be a text box for specific other feedback from the BTs. We could also slice and dice the BTs. So a BT indicates that he will participate in kathink Corporate surveys, and agrees that we can use his personal data to nominate him for applicable surveys. So a Corporate wants to survey men between 40 and 50 who live in the US on a product question. BTs on our site who tick that they will participate in surveys, and who are between 40 and 50 receive a copy of the kathink key for that survey, and fill it out etc. Eg a Corporate insurer, is looking at designing a more attractive product to arrest a slip in its market share. It thinks that where its customer service centre is located is a low importance issue for adult clients. But the kathink key survey shows that in fact it was the second highest ranked issue—everyone is tired of poor quality offshore CS. So for 20 USD timems 1000 BTs the Corporate gets this info, from the right group of BTs with good site feedback and therefore pretty reliable accuracy for the Corporate to act on. We could charge each Corporate 20 USD per BT to whom the key is submitted, and share half with each BT. This could be a good way to make sure BTs are always getting monetised, even if they are not winning Proposals. We could state that we would hold the first 10 or so survey fees owed to the BT against next year's site fees, just to keep the payments simple, and thereafter cut a quarterly cheque to the BTs for the excess survey fees. We could call this business on the site: “Kanvass”. It is not quite phonetic, but I think it is good enough unless you can think of a better name. Can you please ask Gemma to register www.kanvass.com, .eu and .co.uk?

### The Kathink Key

Issue:

We need to design a key technology or business process which captures the heart of the Kathink business model, so that we can patent the process and use patent laws to protect the business from competition. The requirements for a valid patent are:

1. Commercial Application. The invention must be commercially applicable, implementable and reproducible;

2. Novelty. An invention is considered novel when it is not part of the prior art. To decide whether the invention is novel, it must be compared to the state of the art worldwide. Knowledge which has been published prior to the patent application cannot be patented. Hence we need to submit the patent application before we launch the business;

3. Inventive step. The invention must not be derived from the prior art in an obvious way from the prior art (by a person skilled in the art).

Patentable Processes for Kathink:

The heart of the Kathink business model is a platform for Corporates to submit their Business Issues onto for consideration and solution generation from the Kathink membership of Business Thinkers (“BTs”). The Corporate needs to be “tempted” by a brief synopsis of a proposed idea or solution, and then feel sufficiently comfortable with the BT and his Proposal, to Commission the full details from the BT. The third step is full payment by the Corporate to the BT, and to Kathink for its site commission. This whole process—Request, Proposals, Proposal vetting by the Corporate, negotiation of Final terms and fees, the preparation and submission of the Commissioned Response, satisfaction by the Corporate with the quality and business value in the Commissioned Response, and also the legality and cost of the Commissioned Response, and full payment without reservations—must be a quality experience for both the Corporates and the BTs, for the site to continue to attract and maintain paying Corporates and quality BTs. The 2 critical aspects here are (i) creation of real business value for the Corporate via the site, and (ii) without seeing the detailed Response, the Corporate having the confidence to Commission the Response up front.

Starting first with the Corporates, the Corporates must find real business value on the site for it to succeed. The following is required for this to happen:

NOVEL: Whatever the business issue in the Request, the critical issue is that a Proposal must have a NOVEL idea at its core. Each employee of a Corporate who submits a Request has a certain level of current knowledge and thoughts on the subject matter of the Request (either his own level or his own level enhanced by the level existing within his Corporate or business unit). The Proposal must be a new idea for that employee (not necessarily for the marketplace generally or other Corporates, but just for that employee in that Corporate), and preferably not obvious to the employee as just a slight extension of his existing knowledge;

COMMERCIAL APPEAL: The Proposal must appear likely (or even better, very likely) to be commercially successful if implemented (a good strategy, a good branding idea, a good idea on cutting costs etc);

OPERATING ENVIRONMENT: The Proposal must be something that the Corporate would want to, and could, implement. So it must be sensitive to the general profile of the Corporate, its country of activities, the regulatory overlay for the industry in which it operates, its level of business ethics, its major competitors and their products, existing business partners, distributors etc That is, it must be workable within the operating environment of the Corporate.

For Novelty, on the Request page which the Corporate fills out, we should structure this as follows:

Box A. The details of the business issue which the Corporate is looking for a solution or BETTER IDEA on;

Box B. The Corporate's current BASE CASE solution to this issue.

Box C. Specific aspects of the business issue which the Corporate DOESN'T want looked at in Proposals, or specific solutions which the Corporate doesn't want Proposals on (eg it has already considered those).

Boxes B and C would be optional, but we should recommend that the Corporate fills these out. This is because this detail is fantastic for the BTs to understand the current state of knowledge of the Corporate on the business issue, so they can then formulate Proposals that arc likely to be valuable to the Corporate—novelty, commercial appeal, operating environment as above.

Box D which would follow the above and would contain the “Kathink Key”. The Corporate would be asked to fill out anywhere from 10 to 100 text boxes which would contain brief (a few words each) details of aspects of the business issue the subject of the Request, which the Corporate is currently aware of, struggling with. Sub-aspects of different aspects of the business issue, and sub-sub aspects could be included here, and both negative and positive aspects. So, essentially the Corporate's current slate of learning and understanding on all the advantages and problems with the business issue would be briefly listed. The Corporate would then fill out a number of further boxes with “red herring” (“RH”) aspects—aspects and implications which at first glance would appear relevant to the business issue, but in fact after detailed thought by a quality BT, the BT would realize that in fact these RH issues have no relevance. The Corporate would also include 10 or more “red flag” (“RF”) issues in further text boxes. These RF issues would specifically address business knowledge gaps, ethics gaps, operating environment gaps etc that would allow the Corporate to quickly conclude that BTs who fail to understand the importance to the Corporate of these RF issues are very unlikely to possess the skill sets to be able to write Proposals that will be of business value to the Corporate. So the Corporate can eliminate these Proposals from those that he wants to consider further.

The Corporate then assigns 500 Kathink Key points across the text boxes, in order of their “importance” to the business issue, by dragging horizontal solid bars (probably white bars with a black or silver frame, keeping with the site colour coding of while for Corporates and black for BTs) to the left of the text box, out to the required number of points for that box. So very important aspects of the particular business issue would have a high number of points and a long bar out to the left, and less important aspects lower allocations and small bars out to the left. The RH issues would have no allocations (but for diagrammatical purposes all bars would have a 1 unit starting point, like a vertical backbone for the Key.) Vertically, the bars would all touch each other with no gaps, so that the barchart out to the left of the boxes looked like a “key” with a large number of different length prongs—the “Kathink Key”. The RF issues would also have a zero allocation.

The Corporate would then press “submit” for that Request. The system would then automatically “shuffle” the text boxes and bars (but each specific text box and its bar/point allocation would stay joined) vertically, so that there was now a random vertical order of the total aspects of the business issue. The system then saves this as the definitive “Kathink Key” for that Corporate's specific Request.

On the BT side, the BT sees the Request setting out the 4 boxes—the details of the business issue, the current Base Case the Corporate has, the specific Don't Wants, and the Kathink Key. However the Kathink Key that the system lets the BT see does NOT show the bar-graph key of the Corporate, but only the text boxes, in their scrambled vertical order. The BT is then recommended to (i) read the first three boxes and research and think about the issues raised and their underlying aspects, and any ideas or solutions that he can generate to the Request. He is then encouraged to fill out his Kathink Key match for that Request—that is, he then allocates 500 Kathink points across each of the vertically listed text boxes, including the randomly ranked RH and RF boxes (but the BT of course does not know which aspects are RH or RF).

When the BT has done this, he writes up in his Proposal brief details of the core novel idea in the “Pitch” box on the Proposal form, and submits this, which also includes his Kathink Key allocations, his FeedBack Records, and his Mini CV. Of course the system does not scramble his KK allocations before it sends them. But what it does do is, as a last step before it sends the Proposal, it shows the KK of the BT in its mirror image. That is, if the BT had drawn one bar out to say 100, this would have been shown as a solid black bar (black for the BTs) going out to the left of the text box for that aspect. On the final screen before submission, the minor image of the whole KK key as allocated by the BT is shown in black starting from the left hand edge of the screen (actually the text box number is on the extreme left), dovetailing in horizontally with a white (silver lined) matching allocation going over to the right hand edge of the screen. So the whole key is a solid block, but with a sort of jagged zipped down the middle, and on the left of the zipper is the mirror image of the BTs allocations, and on the right, what the BT thinks is the Corporates allocations (and in between, the link, the zipper if you like, is Kathink). I will scan you a sketch of this in the morning if it is not clear.

When the Corporates receive Proposals to their Responses, any Proposals which contain a close approximation of the BT key to the secret Corporate's key are automatically highlighted and prioritized to the Corporate as Proposals which are likely to contain quality, thoughtful ideas. The Corporate reviews the remaining Proposals based on the quality of their Pitches (as above, a brief outline of the novel idea at the centre of the Proposal), but also in the light of Kathink Key analytical data—does that BT understand the business context in which the Corporate operates, did he understand the business issue with any sophistication etc.

The BT will also confirm in his Proposal, that his idea (i) is a general solution for the Request in the light of the BT's Kathink Key (so the Corporate knows if the BT's Proposal Kathink key shows a close alignment with the Corporate's secret key, and the BT confirms that his full idea is consistent with these sensitivities and is a potential solution to them all); and that (ii) if a Base Case is filled in Box B, that his idea in his Proposal is a better solution in his opinion (based on his Kathink Key analysis) to the business issue than the Base Case.

So a Corporate employee has 4 tools to use to decide whether he wants to commission full details on a Proposal to a Request from him—(i) the “Pitch” in the Proposal (which will be even more relevant if the Corporate has filled out the business issue with enough detail and also filled out the Base Case and the Don't Want boxes, so the pitch idea in the Proposal is “novel” for the Corporate); (ii) the Kathink Key analysis indicating the level of sophistication, issue awareness (almost the case as indicating whether the BT is an “expert” in that business field), corporate environment generally and specifically to the industry that the Corporate is in, ethical attitudes, and country, culture and ethnicity awareness and sensitivity; (iii) the FeedBack Records of the BT (including feedback from Corporates on prior Requests as to whether the BT was generally accurate in his confirmations that his idea was consistent with his Kathink Key analysis and whether it beat the Base Case based on his Kathink Key criteria); and (iv) the Mini CVs (which will follow a standard site format where only basic criteria such as number of years of business experience, areas of work experience or claimed expertise, areas of interest and why the BT's knowledge would be capable of business value in these areas, and areas of academic specialization; but NO affirmations of being licensed in a field or being an expert adviser in a field). With such a high level of support, the Corporate then has sufficient confidence if he sees green lights in all 4 tools, to go ahead and Commission a BT in a binding contract, ahead of actually meeting or knowing the BT, or having seen any real professional work from them. This is the critical Kathink business process which we want to patent, focused particularly on the Kathink Key. The Kathink Key will also be useful when the business commences, as no BTs will have much Feed Back data, meaning that a close alignment of the Kathink Key allocations will be probably the Corporate's strongest indication that the BT is a quality operator who is going to submit a quality, focused, useful Response if the Corporate takes the risk and Commissions him. So the Corporate can screen out upfront any Proposals whose Kathink Key show allocations to RFs or RHs or generally get the priorities wrong demonstrating little or no expertise or understanding the subject matter of the Request. Generally, the more sophisticated the Corporate and the more sophisticated his business issue, the more text boxes and effort the Corporate should put into the creating the Kathink Key for the particular Request. If the Corporate is small or doesn't care about screening out poor quality Proposals, they can just prepare brief Keys or leave the step out altogether.

This process also means that while a BT must indicate (via his Kathink Key allocations and their alignment to the Corporate's alignment) that he has completely thought through the idea at the centre of his Proposal, he does NOT have to have actually pre-written the whole Response, ahead of a binding commitment from the Corporate that this work is required and will be paid for, and he will not have wasted his time (versus having to write the submissions for each Proposal and keep them with some sort of verifier third party). Generally, the BT uses his Proposal (especially the “Pitch” of the novel idea at its core, and the Kathink Key alignment fit) to TEMPT the Corporate to Commission the full details of his idea from the BT.

This all leads to the act of Commissioning a Response: the user agreements for the Corporates will clearly state that once a Corporate enters into a binding, online contract with Kathink SA as the marketplace, then the Corporate does so on a “caveat emptor” basis, and that (barring clear fraud or materially misleading activity in the process leading to the act of Commissioning), the Corporate is legally bound to pay the agreed Commission Fee, and waives all legal rights to object on the grounds of misrepresentation. The site will ask the Corporates to agree to this contractual and payment position based on the strong vetting procedures the site offers to the Corporate ahead of the act of Commissioning (especially the Kathink Key).

As a further business application, Corporates should also be encouraged to “Stress-test” their Base Case idea on a certain business issue, on Kathink SA prior to a rollout of the idea in their business. The stress-test asks the Kathink membership to come back with weaknesses in the concept and also to suggest a better concept (as above) prior to the Corporate investing real money in implementing the Base Case idea.

Kathink SA could also be used by Corporates to assess the suitability of potential recruitments into the Company. The Corporates set up hypothetical Requests on a range of business issues and ask only selected BTs (the ones they are looking at recruiting—perhaps the Corporate's HR or recruitment consultants set the candidate up on Kathink for the purposes of the analysis, which could also include a look at the candidate's performance versus the general performance on the issue from the membership) to submit Proposals, and the Corporate pays particular attention to the Kathink Key fit.

NB We will encourage the Corporate to think of listing his business issue as a “hypothetical issue” as per US and general legal advice on the topic, rather than a real factual scenario which he is seeking “advice” on via the Kathink site.

NB for Ian and John: We have generally downplayed now the whole anonymity issue on the site. Both Corporates and BTs will be able to tick on the relevant correspondence that they with to operate on a non-declared basis, and will use site names rather than their real names in this case. The user agreements will also state that, especially where the other party to a Commisioned Response indicates that he wants to operate on a non-declared basis, the other party will not communicate to any third parties any information about the Commissioned Response or any correspondence leading up to it, not the identity of the other party. This confidentiality clause will also apply generally to all users of the site.

### Kathink intelligence Systems

Business Concept: Corporate Strategy Conception and Project Evaluation

All Corporates or economic units (any body with a common ownership) must have a process for decision-making, for strategizing, for business creativity and the creation of business value etc. Most Corporates keep this at the Board level, or senior management, or specific business unit management, assisted with external advisors. Kathink Systems aims to provide Corporates with a business tool that they can license and use to:
1. Conceive business value Stratagems within their Organization, or a specified portion of that Organization, or enabling the maximum creative contribution of Business Value from their entire workforce.
2. Do this in real-time, including saving, storing, retrieving etc all Stratagems stored, which can also create business records of inventions for the purposes of intellectual property laws, or in order to create business value by inventing patentable processes and inventions.
3. Take specific business issues or pieces of those issues to the global Kathink member-base of Business Thinkers to either find a better idea or solution to an issue, or to stress-test a particular Stratagem.

The process works as follows.
1. The Corporate licenses an enterprise version of Kathink, which is hosted externally (could be a software download, but web-hosted applications are much easier for Kathink to administer, software updates happen automatically etc—depends whether the Corporate will agree to having its Kathink enterprise data stored and hosted externally).
2. The employee of the Corporate who is the business owner of a particular Stratagem (“the Conceptor”), prepares 4 Kathink keys for the particular Stratagem. The concept and use of the Kathink keys, and their unique concept of a user allocating points across specific aspects of an issue, are discussed in a separate Note. Note that of course we could just allow the Corporate to prepare one Key, with the attributes of all four keys below in it—we will recommend the 4 keys, but allow for just one key with many text boxes entries, to permit the creation of one, very detailed and complex key if the Corporate finds this more useful or more simple to use. Also, we should patent keys which go into the negative as well as positive, although I am personally against using the negative, but we should reserve the patent rights anyway.
3. The First Key is for the “Change Trigger” itself—that event (eg a proposed change in the regulatory environment) or desire (eg to improve the performance of a particular SKU) which has triggered the need to conceive a Stratagem.
4. The Second Key is for the Business Issue to which the Change Event relates. Eg the poor performance in the last quarter of the Coke Light brand in Northern America.
5. The Third Key is for the Business of the Corporate itself—its operations, its regulatory profile, specifics of the business economics of its business etc. If the user wants to add a specific key for a business unit within the Corporate, prior to completing the Corporate key, the user then sets 5 keys. There is no limit to the number of keys which the user can set—it is just a matter of how much time he wants to put into the process, and how much detail is required for the keys to capture all the sensitivities and aspects of the Business Issue.
6. The last key is the Big Picture key, which is the broader, global context of the Business Issue and the Corporate.
7. All keys can be saved together under the name of the one Business Issue, and are opened together from the one file. So the Conceptor now has 4 completed keys, of which he looks mainly at one at a time, but can enlarge and minimize, and cross-reference and compare etc the other 3 using a series of site tools.
8. The Conceptor then prepares a Request, which can either be specifically directed to a specific group of employees, or it may be sent generally to all employees in the Corporate using meta-tags (pre-supposing that each employee of the Corporate has to register in the kathink enterprise system with a series of meta-tags relevant to their experience.) The Request would have a Request box which would outline the Change Event, and the Business Issue, Business Unit, Corporate and any particular external implications.
9.The Conceptor can now send the Request to the selected Recipients. The Recipients when they receive the Request first of all read the text detail in the Request box, and then analyze the keys, trying to get an understanding or a “Perspective” on each key issue. The Recipient is then encouraged to amend any weightings of keys with which he disagrees, and send these back to the Conceptor. Eg, the tax director while reviewing keys set by a Conceptor, may see a large allocation of relative Business Issue Importance about the solution to the Change Event pulling down the global tax structure, but the tax director communicates back that this concern is overstated or misplaced for reasons XYZ. So the key is amended by the Conceptor if he agrees—it is HIS key to amend.
10. Rather than each Employee receiving a bunch of email click-throughs to keys each day, instead each Employee will have a dedicated page on the hosted enterprise version, where all Kathink correspondence relevant to that employee will be hosted. Perhaps a small image would flash on the employee's computer screen if there has been a posting to his page which he has not opened, to notify him to enter the application and look at the issue.
11. The next stage for each Recipient is that the systems prompts him to (i) STEP INTO THE FUTURE to that point where a Stratagem which was a solution to the Business Issue and the Change Event WAS DEVELOPED, and which created Business Value for the Corporate; and (ii) to ask himself “What was the ONE critical change in process or inventive step which lead to the successful Stratagem (“the Key Change)?” (A Recipient can of course submit more than just one Key Change, but the focus should I think be on finding that ONE, most important key change that he can CONCEIVE, given his PERCEPTION via the Keys of the entire Business Issue). Alternatively, the system could give the Recipient the option of just submitting what he thinks is the most important Key Change to be made to solve the Business Issue, with no challenging reference to “stepping into the future to create retrospectively” but I don't this that this process is as powerful, creatively stimulating or unique (for patenting purposes) as the process above—go into the future to where the successful solution is, and ask what was the Key Change required to create the solution. My premise is that the “Step into the Future” is very creatively enabling for the human brain, and also forces it to assume upfront that a solution is available—it is just a question of the individual being able to PERCEIVE THE SOLUTION.
12. The Recipient then submits his Key Change back to the Requester, as either a text note, or a voice-data package (ie he verbally speaks his Key Change into the microphone at his PC, which records it as a data file and sends it to the Requester), and/or with an attached diagram explanation.
13. When the Requester is ready to view the Key Change Submissions, he opens a special window in his Kathink application, called a “Kalaxies” window.
14. This is a representation of a solar system, with a medium-sized yellow (or gold for Kathink branding) Sun in the middle, and black space around all outside. The Requester then opens the first Key Change submission, and reads or listens to it. If he thinks it is great, he places it near the Sun (by clicking on a Planet Icon—he can also choose the size of the Planet Icon, to help indicate the relative merit of the Key Change idea behind the planet).
15. The Requester can also respond to the Recipient and question etc any part of the Key Change submission (perhaps by some form of Skype enterprise application) or just by telephone or real-time text messaging over the Kathink enterprise application. If the Conceptor does not like the Key Change submission, because he thinks it does not offer the possibility for significant Business Value, he places it far from the Sun and small in size (eg “Pluto”).
16. The Kalaxy for that Business Issue can also be viewed by other Recipients of the Request—they all have access to that particular Kalaxy via the system. They just move their mouse over the planet that the Conceptor created, and the text behind that Key Change submission is displayed in a pop-up box, or the sound data file plays automatically so he hears the Recipient talking of the Key Change Submission etc. The other Recipients can also respond to the Key Change submission shown in the planet, either to the Conceptor, the Recipient that created the Key Change Submission, or all Recipients. Each Planet can be of itself a store of related ideas and communications—that is, the Recipients click through the Planet to open up all the related communications. Also, the kathink enterprise version will have an internal search engine that searches across all Planets and Suns saved on that Corporate's kathink application, for matching terms, images, perhaps even verbal data. The Corporate will have the ability to have the ideas, information and communications for particular Planets classified by the system as “Classified” and only available to be seen by a pre-set class of employees, and the internal search engine would either not show this information or would indicate to a user that it exists but is classified—and perhaps it also shows the user the name of the employee that the user has to go and see to get the classification lifted so the user can view the information. In addition, the Conceptor has the power in the system to save Suns into a Galaxy of related Suns—a visual representation of related Business Issues which the Corporate can either pre-configure (eg a Galaxy or “Kalaxy” for each business unit in the Corporate, which then feeds into the “Universe” of the Corporate's business activities. So employees can “surf” visually across a Corporate's whole business clicking on whatever Planets, Suns etc arc of interest, or get to a particular Galaxy or Sun or Planet via the internal search engine just to get to a good starting place for a research project etc, and then click onwards from that starting point. Kathink could also permit for the cross functional functions that many large Corporates have (eg such as Tax or Legal or Treasury which are HQ functions which report and operate in a cross matrix fashion across the Corporate's operating business units) to appear in the Universe, as a “Milky Way” which perhaps has a milky while backdrop over the black universe background.
17. So the Conceptor prepares a “relative solar system or galaxy or universe” of the Key Change Submissions from the Recipients to the Request, visually ranked in accordance to the Conceptor's judgement as to how much Business Value he sees in the various submissions (Planets closer to the Sun and bigger contain more Business Value—perhaps bigger but not closer indicates greater potential but not greater probability of being a stratagem which is likely to be successfully implemented—the bigger the planet the greater the prospect for success, the further from the Sun being the lesser likelihood that the particular stratagem could be implemented,
18. Once he is sure that the Key Change submission behind a Planet will be part of the final solution to the Business Issue, he drags that Planet into the Sun, where either it no longer can be seen in the Galaxy, or perhaps appears within the Sun as a “Sun Spot”. The Conceptor or any of the Recipients may then click on the Sun at any time to see which Key Change submissions will be part of the final Stratagem, and the details of those submissions by clicking on the Planet inside the Sun (Sun Spot).
19. The final recommended Stratagem is then created and detailed by the Conceptor from the Key Change submissions that he likes, and written up and published back to all the Recipients for any final comments or changes.
20. At any stage during this process, the Conceptor may take the whole Business Issue or just a small part of it which he and/or the Recipients generally are struggling with, and post it quickly and easily onto the EXTERNAL Kathink site. The key for the Kathink site can be completed easily from the detail already configured for the 4 internal keys (see above).
21. Alternatively, the Conceptor can take his final Stratagem and post it on the external Kathink site for stress testing ideas and feedback. Most companies would not put their full business ideas on the external site, so perhaps a hypothetical version which merely contains the particular aspects of just a part of the Stratagem which the Corporate has concerns about, is posted.
22. All aspects of the use of the internal Kathink tool and Key Change submissions etc can be easily stored and used by a Corporate's HR to review the performance of employees. Or perhaps a hypothetical Request is set up and candidates (employees or candidates for employment) for a position sit a Kathink test where they are invited to prepare Key Change submissions back to the Conceptor, which is in this case, HR.
23. Perhaps also employees who contribute strongly to the creation of business value in the Corporate as measured by the quality of their Key Change submissions or their work as Conceptors, receive discretionary bonuses based on the Kathink records.
24. The use of the keys allows both the Conceptor and the Recipients to improve and to achieve relevance in both the creation of Key Change submissions and the final Stratagem, by improving their ability to PERCEIVE the issue in all its aspects, relevantly weighted, and Lo PERCEIVE what the Key Change and the final stratagem, could be.
25. A tagline for the Kathink enterprise version could be “Kathink Systems—a real-time, collaborative, business value creation tool”.
26. The tool has the benefit of maximizing value creation within a Corporate by engaging the creative powers of each employee to the Business Issue, and providing a means via the Kathink keys where each employee is able to perceive the Business Issue in sufficient detail and clarity to be able to creatively contribute to Business Value creation by the Corporate. So now its not just the creativity of the Board of Directors, their trusted external advisers or close senior management which creates business value for a Corporate, but in fact, relevantly and in a controlled, confidential manner the Corporate now leverages the TOTAL CREATIVE CAPACITY of its workforce.
27. The Kathink enterprise system could then also be used in subsequent steps—that is, in the implementation of the Stratagem which was formed on Kathink, So once the Stratagem is approved internally, a new Request is submitted for the IMPLEMENTATION process. Then the same process as above occurs—the Corporate brainstorms on its Kathink application (supported by the external Kathink site and Business Thinkers if needed) as to how best to implement the Stratagem in all its details—resourcing, timing etc.
28. Once the implementation Stratagem has been finalized, aspects of the keys used in either the initial Change Event Request process, or the Implementation Request process, could be made easily into a key which is then sent to the chosen service providers as an overview of the sensitivities of the particular task, and to demonstrate the relative importances the Corporate places on them. Or a key with red herrings and red flags could be prepared to be sent to competing service providers, as part of the selection process for which service provider the Corporate may choose between for the service engagement.
29. The key, particularly the SHAPE, could also be used by Kathink in a third party verification process business. A bit like the VPN process. So a Corporate gives a key shape to Kathink, with a certain instruction (such as to notify Bank X that the test key has been received) once anyone sends to Kathink the matching key. Or in lottery or give-away promotions etc—the promoter distributes on the back of supermarket receipts different key shapes, and Kathink notifies a third party once a matching key has been submitted. Etc.
30. The key could be used by Corporates to gauge the level of awareness and fit of any external service provider as above in 28. The key could also be used by individuals or Corporates when deciding on investments with a broker or fund manager for example. The Individual sets a key with red herring and flags and then asks the fund manager to fill out the a blank version of the key (with only he scrambled text boxes completed, as in an online key on Kathink.) The individual then gauges whether the fund manager really understands that individual's TOLERANCE for risk versus reward. This could be the last step after a series of meetings, prior to the individual signing up and transferring his funds—one last “fit” test.
31. All keys prepared by Corporates would be saved by Kathink as well as all supporting communication. So in many cases the Corporate would not start a new Kathink process completely from scratch—he would just call up a prior key as a starting place, resave it to the new project, and start amending it. Also, I think after a little use, Corporates would have standard text boxes and keys that the Corporate always used in certain circumstances etc.
32. The Corporates could also set a Code key for any Request process. This would provide that the Corporate sets a key with Code names for any entities or people which would need to be referred to in the course of brainstorming the Stratagem, and these names would be set in a Code Key with a Code name. The Conceptor would be able to set the system so that only certain of the Recipients (eg Senior Management) would have access to the Code Key to know exactly who was being referred to—these Recipients could open the key to check, or perhaps in their pages the system automatically uses the real names, at the option of the Conceptor/Corporate. The other Recipients would just see the Code names.
33. The Completed Key could be given to service providers as part of an external briefing on a service engagement—the service provider starts with a “running start” on the topic.
34. The key can also be extended for application inside a Corporate as a “Project Probability” or Project Approval or Project Decision Making system—perhaps part of the standard sign off process or any internal resource or funding commitment. It could work as follows. The internal applicant for funding for a project would be required to fill out a “Kathink probability key” for that funding request. This is just a particular template of the key, again available on the enterprise version of Kathink. The template key has a project name, under that a two-step key. The top step is a normal key—bars to the left and text boxes to the right. This key is referred to as the “Positive Outcome” Key, and there are 1000 points as usual in this key. The text boxes each state one possible event in the positive outcome universe for this particular project (for which the funding is requested). On each bar opposite each outcome, the user can click on the bar, which takes him through to a computation page. This page requires him to calculate (i) the percentage possibility out of 100 for that event to occur, TIMES (ii) the CONSEQUENCES if that event occurs. There are 1000 total points to allocate across the Positive Outcome Key. We could also add a “probability pie” with a circular visual representation of the universe of possible positive outcomes, which the user of the key would then add Consequences to, to arrive at the allocation of the 1000 points across the Positive Consequences Key. Under this key, connected by a small vertical bar. would be the negative outcomes key. Similarly it would contain text boxes and point bars, but the text boxes for each event would be to the left, and the bars would go out to the right. Again the settor of the key would allocate the universe of negative outcomes on a probability pie, and against each outcome assign the cost of the CONSEQUENCES of that event occurring, to arrive at a spread of the 1000 negative points across the key. But there is one major difference with the negative key—for the project to be approved for funding, CLEARLY the negative allocations must be less than the positive allocations—otherwise if they are equal it's a wash and the Corporate is in most circumstances) better off spending its money elsewhere. So in each negative key would be automatically preset as the last text bo and bar, and highlighted visually in red or similar, a PROJECT NET BENEFIT allocation—equivalent in some ways to the “equity” allocation on a balanced sheet—assets are equal to liabilities PLUS equity. It would calculate automatically as a balancing entry across the 2 keys. So the settor of the key must demonstrate to his superior who is being asked to approve the funding, that there is a NET BENEFIT on a probability and risk adjusted basis, that meets the Corporate's internal hurdles for ROI, years of investment payback, tolerance for business risk etc. The Superior can communicate with the Corporate and grill him on why he thinks a certain aspect of either the positive or negative key is what he has concluded in his funding pitch as set out in the Key, and also his question him on his perception of the consequences if that positive or negative event occurs. And of course raise positive or negative implications which have not been thought of by the settor. All in all, the use of the key results in (i) better decision making by Corporates, and (ii) a higher level of comfort and Sarbannes Oxley audit trail corporate governance confirmations that the management of a Corporate, especially a listed Corporate, are “best in class”.
35. Again, employees performances using the Kathink Project Probability keys could be used by HR or management to promote, criticize, make bonus payment to etc. It is a comprehensive test of the employee's ability to PERCEIVE the probability universe of business opportunities, consequences and implications of projects that they, or the Corporate more generally, are involved in.

### Kathink as a Preferences Tool

The Kathink Key has major potential commercial applications beyond facilitating the operation of the online ideas marketplace.

In particular the Kathink Key has an application as a “Preferences Understanding” tool for every individual and corporate to use in relation to every service relationship that they have entered into, or will enter into, and every good which they are considering purchasing.

For example, Kathink Ltd will permit legal persons (corporates or individuals) (“the Key Users”) to licence either a downloadable version of the Key which they can keep in their hard-drive, or a hosted version of the Key which Kathink will administer and host for them. The “version of the Key” means the core Key functionality—ability to set the Key, save the settings, scramble the order of aspects, send electronically via the internet a “blank” (I think “blind” key is actually a better term) to a commercial actor they are thinking of engaging, the actor completes the key returns it electronically via the internet to the User, and the algorithm in the key completes the “Comparison” versions of the Key and shows the User a visual “Fit” comparison and/or text comparison and analysis.

The Key User can then set Keys and send them to every service provider that they are using, to test whether that service provider really understands the service requirements and issues, and the relative importance of the those issues, to the Key User. The Key User can then analyze the Comparison or Fit on the Key and then make a decision as to whether he or she wants to continue with that service provider, or select another who has a better Key Fit (and therefore understands better what the Key User wants, needs, expects from the service relationship.) That is, the Key can become a tool for Key Users to obtain TAILORED services and goods from anyone they interact with commercially. It can even be used for domestic purposes—e.g., nannies are asked to complete a Key and the Mum uses the Key Fit amongst other things to select the Nanny.

We could have everyone in the world including all corporates regularly filling out Keys as a first or fundamental step in every financial or commercial process they are thinking of entering into. This would empower the world's consumers by forcing the world's service providers and good developers to tailor all goods and services more and more to the preferences of the end user—that is, the Key User. At the same time service providers and goods developers may actually appreciate receiving such comprehensive information about a potential customer and his or her preferences, to ENABLE them to PERCEIVE more accurately what the consumer wants, resulting in a more satisfied and more loyal consumer.

The Key would not need either to be completed and sent in a blind format to the potential service providers or goods developers. The Key User can just use the functionality of the Key to send a completed Key, with all the text aspects and the percentages weighted importances set out clearly, just as a quick way for a Key User to communicate accurately what he or she is looking for from the service provider or the goods user. This then leads to discussions and communications between the Key User and the service provider, again resulting in a more tailored product and a happier commercial relationship.

Another very valuable attribute of the completed keys, particularly where Key Users permit Keys on their commercial preferences to be hosted on Kathink, is that Kathink then has for these individuals, a pretty detailed profile of what is important to that individual. This becomes the very profile data or preferences data that the major ecommerce companies are right now trying to work out a system to legally collect from individuals and companies. Eg Google looking to try and obtain profiling and preferences data on google site users based on the methods and patterns they use to search online, or to play online computer games etc.

This data could be sold (with the consent of the Key Users) to service providers looking to sell or tailor services to potential customers, or for product development purposes, or service providers could be given access online to the data which they could then analyze etc.

What is claimed is:

1. A system for screening requests for proposal and matching said requests with high potential solution providers, the system comprising:
a host computer in communications with a computer network;
a screening and matching process resident and executable on the host computer, the process adapted to accept data input from a proposal requestor and from a proposal responder and to output data to the proposal requestor and to the proposal responder, and to define a requirements data set and to receive a response data set,
a proposal request key generator which operates on the host computer via the computer system network generating a key representing the requirements data set and to output a proposal request to a proposal responder, and
a response key generator which generates a key that represents the proposal responder's reply to the requirements data set, the response key being processed with the request key to provide a proposal key which is output from the host computer via the computer network to the proposal requestor
wherein the requirements data set of the proposal request is enterable into the screening and matching process by the proposal requestor, the requirements data set being operated on by the screening and matching process to provide the proposal request key; and wherein the response data set is enterable into the screening and matching process by the proposal responder, the response data set being operated on by the screening and matching process to provide the response key.

2. A system for assessing the extent to which a second responder person similarly perceives and understands a business issue relative to the business issue as perceived by a first originator person, the system comprising:
a host computer system in communications with a computer system network;
an assessment process resident and executable on the host computer system, the process accepting data input from the first issue originator person and from the second responder person, and outputting data to the first originator person and to the second responder person, the assessment process including a key generation and comparison algorithm;
an issue parameters data set of the business issue entered into the assessment process by the issue originator, the issue parameters data set being operated on by the assessment process to create a business issue key and a business issue key blank, the business issue key blank being output from the host computer system via the computer system network to (selected) the responder person; and
a response data set entered into the assessment process by the responder person, the response data set being operated on by the assessment process to provide a responder's business issue key, the responder's key being to compared to the originator's business issue key to assess the responder person's perception and understanding of the business issue relative the business issue as perceived by the originator person.

3. The system of claim 2, wherein the key generation and comparison algorithm:
creates the business issue key and blank key from the issue parameter data set input into the system by the issue originator person, the business issue key representing a set of issue parameters and originator's set of associated issue weighting factors, and the business issue key blank being without the associated issue weighting factors;
presents the business issue key blank to the responder person and accepts data input from the responder person of a responder's set of associated issue weighting factors to enable creation of a responder's business issue key;
compares the originator's and the responder's set of issue weighting factors to assess the fit of the originator's business issue key with the responder's business issue key; and
outputting a result of the comparison.
